(19) United States
(12) Patent Application Publication
(10) Pub. No.: US 2003/0234554 A1
(43) Pub. Date: Dec. 25, 2003

(54) Hinged motor-vehicle armrest

(75) Inventor: Thomas Maierholzner, Vilsbiburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: SEEBER AG & CO. KG

(21) Appl. No.: 10/434,424

(22) Filed: May 8, 2003

(30) Foreign Application Priority Data
May 8, 2002 (DE) 10220651.1

(51) Int. Cl. B60N 2/46

(52) U.S. Cl. 296/153

(57) ABSTRACT

An armrest assembly has a support, an at least partially elastomeric mounting block having one side operatively secured to the support and another side, a fixed hinge plate operatively secured to the other side of the mounting block, and a movable hinge plate pivotal on the fixed hinge plate about an axis. A latch between the plates can angularly lock the plates relative to each other. An armrest is secured to the movable hinge plate so that, when the plates are locked by the latch means, angular displacement of the armrest relative to the support deforms the block.

### FIELD OF THE INVENTION

The present invention relates to a hinged part. More particularly this invention concerns a hinged motor-vehicle armrest.

### BACKGROUND OF THE INVENTION

A standard motor-vehicle armrest as described in German patent document 198 12 432 filed Mar. 21, 1998 by N. Lotz et al. This structure has a support, a fixed hinge plate secured to the support, a movable hinge plate pivotal on the fixed hinge plate about an axis, and a latch between the plates for angularly locking the plates relative to each other. An armrest is secured to the movable hinge plate, so that when the plates are locked by the latch means, the armrest cannot move angularly relative to the support. The pivot for the armrest is braced by a spring so that if the armrest is forced downward, this spring is loaded. Thus the spring is always in the force-transmission path. Such a system is relatively complex.

### OBJECTS OF THE INVENTION

It is therefore an object of the present invention to provide an improved pivotal cover, in particular a motor-vehicle armrest.

Another object is the provision of such an improved armrest which overcomes the above-given disadvantage, that is which is of simple construction.

### SUMMARY OF THE INVENTION

An armrest assembly has according to the invention a support, an at least partially elastomeric mounting block having one side operatively secured to the support and another side, a fixed hinge plate operatively secured to the other side of the mounting block, and a movable hinge plate pivotal on the fixed hinge plate about an axis. A latch between the plates can angularly lock the plates relative to each other. An armrest is secured to the movable hinge plate so that, when the plates are locked by the latch means, angular displacement of the armrest relative to the support deforms the block.

Thus this elastic block, whose elasticity of about 100 Shore A is substantially more than that of any of the other normally metallic parts of the assembly, deforms to allow the armrest to deflect. The mounting block is very simple yet can withstand considerable forces so as to have a long service life. Since the elastomeric block is integrated right into the hinge, it is located exactly where the torque applied to the armrest is best dealt with. The modules of elasticity and/or compression and/or torque can be quite high so that when subjected to compression and/or shear, the block returns without permanent deformation or damage to its original shape. It is possible to build such a block or blocks right into the structure in a manner substantially reducing manufacturing costs for the armrest assembly, making it particularly effective when used as a central rear-seat drop-down armrest. When no force is pressing down on the armrest, the mounting block is not significantly deformed. Furthermore a slide-type guide as described in the above-mentioned German patent document is not needed.

According to the invention the one side of the block is directly secured to the support. More particularly, one or two screws bearing on the block and seated in the support secure the support to the block.

The block in accordance with the invention is entirely unitarily formed of an elastomeric material, normally a somewhat stiff plastic.

In one embodiment the block is shaped like a wheel as a flexible openwork structure having a plurality of elastomeric inserts fitted to the structure.

The other side of the block according to the invention is directly secured to the fixed hinge plate. More particularly a pin extending from the fixed hinge plate is seated in the other side of the block.

The fixed hinge plate according to the invention has an axially extending collar and the block is at least partially recessed in the collar. In addition it is generally cup-shaped so that radial outward deformation of the mounting block is restricted. Furthermore the block is formed of elastomeric material in turn formed with at least one cutout.

### BRIEF DESCRIPTION OF THE DRAWING

The above and other objects, features, and advantages will become more readily apparent from the following description, reference being made to the accompanying drawing in which:

FIG. 1 is a horizontal section through the rear end of an arm rest according to the invention;

FIG. 2 is a vertical section taken along line II-II of FIG. 1;

FIG. 3 is a detail sectional view taken along line III-III of FIGS. 1 and 2;

FIG. 4 is a perspective view of the hinge structure according to this invention; and

FIG. 5 is a perspective view of a mounting element according to the invention.

### SPECIFIC DESCRIPTION

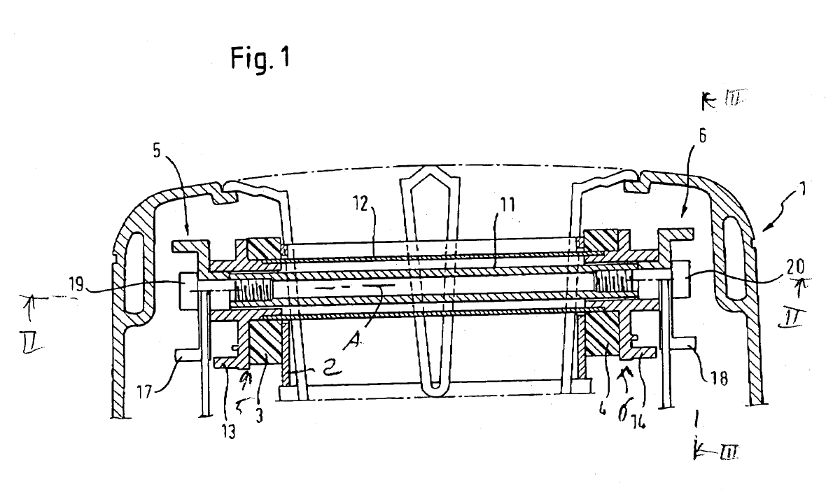

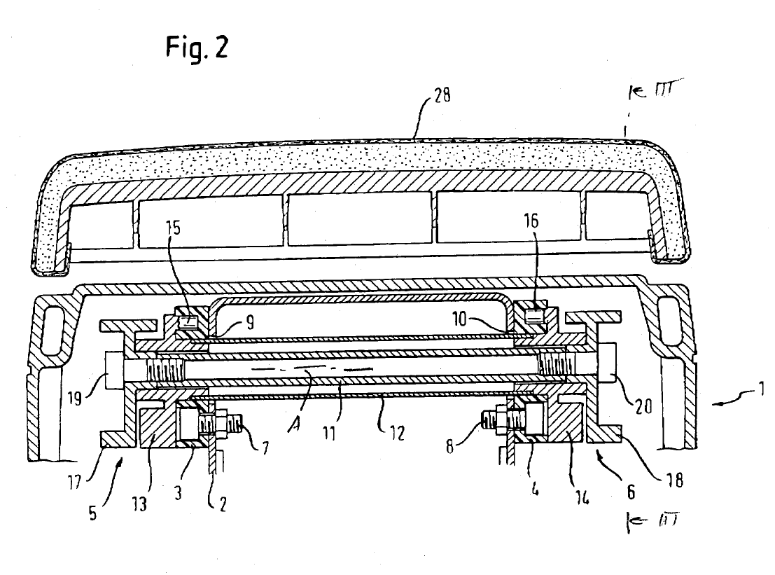

As seen in FIGS. 1 and 2 a an armrest assembly 1 is carried on a structural support part 2 of a motor vehicle, here between a pair of rear seats, to which a pair of elastomeric and relatively soft mounting blocks 3 and 4 carrying hinges 5 and 6 are secured by bolts 7 and 8. The support 2 is formed with a pair of aligned holes 9 and 10 through which pass a tubular hinge shaft 11 defining a pivot axis A, received coaxially in a tube 12.

The hinges 5 and 6 have plates 13 and 14 which are secured to each other by the tube 12 and angularly locked to the blocks 3 and 4 by anchor pins 15 and 16 so that these plates 13 and 14 are connected via the elastomeric blocks 3 and 4 to the support 2. The hinges 5 and 6 further have movable hinge plates 17 and 18 juxtaposed with the fixed plates 13 and 14 and secured via screws 19 and 20 to the ends of the shaft 11 so that they rotate jointly about the axis A relative to the plates 13 and 14 and the fixed support 2. The plates 13, 14, 17, and 18 are formed of cast aluminum while the coaxial shafts 11 and 12 are of steel and the blocks 3 and 4 are of plastic.

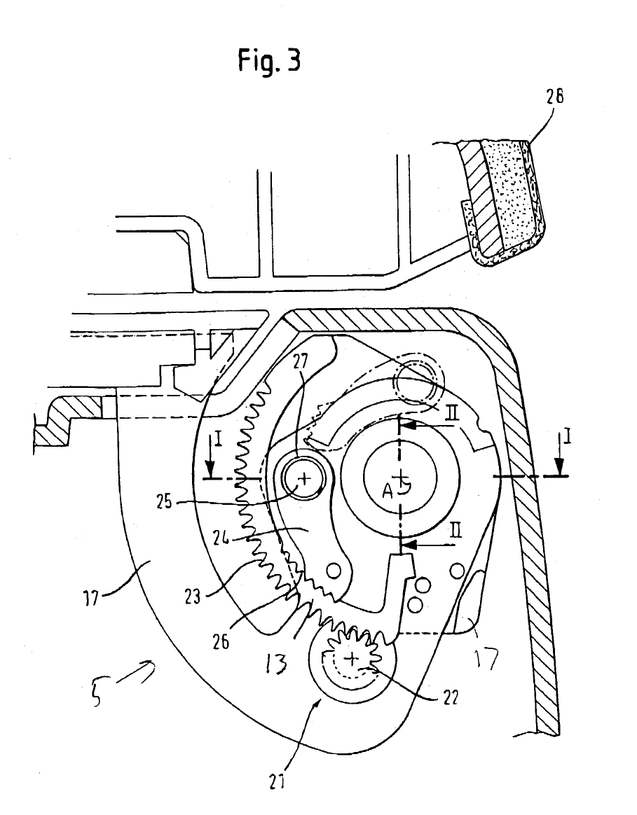

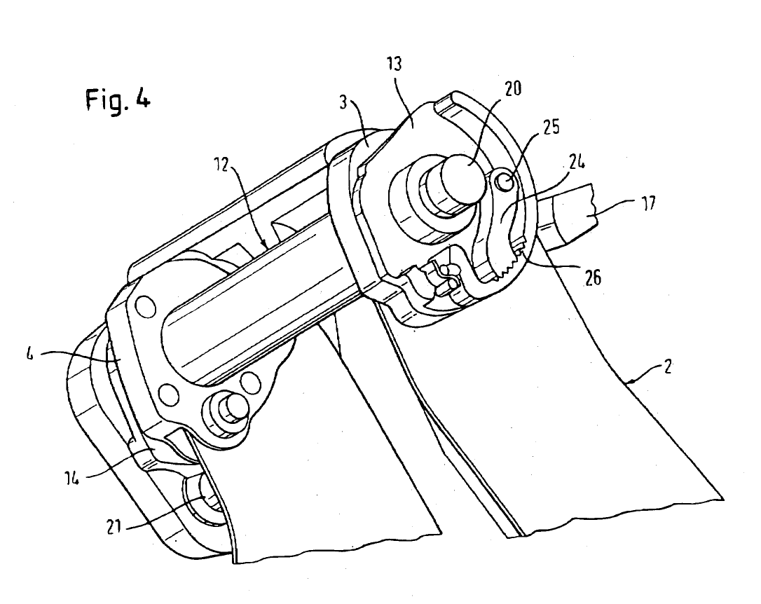

As better shown in FIGS. 3 and 4, the hinge 5, which is identical to the hinge 6, has a grease- or silicone-filled brake 21 comprised of a pinion gear 22 meshing with external teeth formed on the movable hinge part 13 so that pivoting about the axis A is damped. A latch pawl 24 pivoted at 25 on the part 13 is urged by a spring 27 into engagement with internal teeth 26 of the part 17 and can be pivoted inward by an unillustrated button-actuated mechanism to allow a seat back 28 secured to the movable hinge parts 17 and 18 to pivot about the axis A, or to be locked in any angular position thereabout.

Since the fixed hinge parts 13 and 14 are secured via the elastomeric blocks 3 and 4 to the support 2, when the armrest 28 is locked any torque exerted on it about the axis A will result in elastic deformation of the blocks 3 and 4. Thus the armrest 28 has some give; it can be moved, even when locked in place, without damage to itself or its support 2.

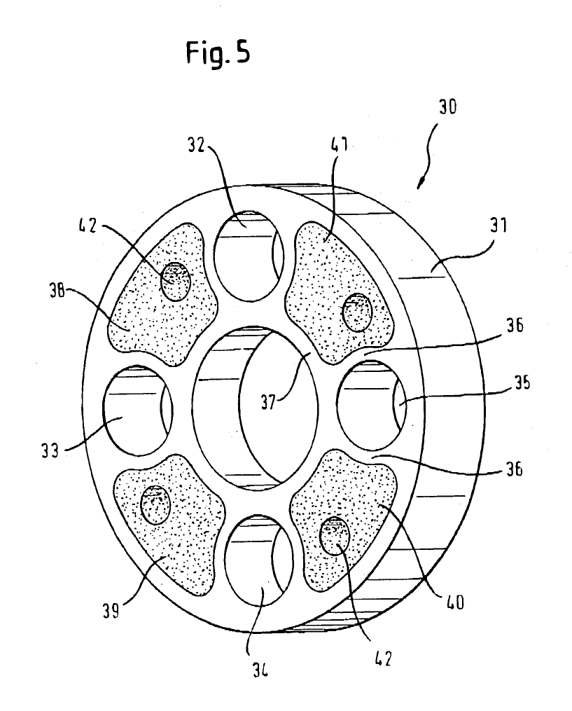

FIG. 5 shows a wheel-shaped mounting block 30 that can be used instead of the blocks 3 and/or 4. It has a hard and flexible plastic rim 31 formed with radial webs 36 protecting inward to an inner ring 37 and forming four angularly equispaced holes 32-35 for screws allowing it to be bolted to the support 2. Between the webs 36 are four elastomeric foam inserts 38-41 formed with holes or pockets 42 dimensioned to receive the pins 15 and 16 that couple the movable hinge plates 13 and 14 to them. Thus the screws 7 and 8 through the holes 32-35 secure the mounting blocks 30 to the support 2 while the pins 15 and 16 seated in the pockets 42 rotationally couple the movable plates 13 and 14 to the mounting blocks 30. The outer tube 11 is rotatably received in the hole of the center ring 37 so that this block 30 is sure to stay on center.

I claim:

1. An armrest assembly comprising:
a support;
an at least partially elastomeric mounting block having one side operatively secured to the support and another side;
a fixed hinge plate operatively secured to the other side of the mounting block;
a movable hinge plate pivotal on the fixed hinge plate about an axis;
latch means between the plates for angularly locking the plates relative to each other; and
an armrest secured to the movable hinge plate, whereby, when the plates are locked by the latch means, angular displacement of the armrest relative to the support deforms the block.

2. The armrest assembly defined in claim 1 wherein the one side of the block is directly secured to the support.

3. The armrest assembly defined in claim 2, further comprising
a screw bearing on the block and seated in the support.

4. The armrest assembly defined in claim 1 wherein the block is entirely unitarily formed of an elastomeric material.

5. The armrest assembly defined in claim 1 wherein the block has a flexible openwork structure and.a plurality of elastomeric inserts fitted to the structure.

6. The armrest assembly defined in claim 1 wherein the other side of the block is directly secured to the fixed hinge plate.

7. The armrest assembly defined in claim 6, further comprising
a pin extending from the fixed hinge plate and seated in the other side of the block.

8. The armrest assembly defined in claim 1 wherein the fixed hinge plate has an axially extending collar and the block is at least partially recessed in the collar.

9. The armrest assembly defined in claim 8 wherein the fixed hinge plate is generally cup-shaped.

10. The armrest assembly defined in claim 1 wherein the block is formed of elastomeric material in turn formed with at least one cutout.

11. An armrest assembly comprising:
a support;
a hinge shaft projecting through the support, defining an axis, and having a pair of ends;
respective partially elastomeric mounting blocks each having one axially directed side operatively secured to the support at a respective one of the shaft ends and another axially directed side;
respective fixed hinge plates operatively secured to the other sides of the mounting blocks;
respective movable hinge plates pivotal on the fixed hinge plate about an axis and fixed to the shaft ends;
latch means between one of the movable plates and the respective fixed plate for angularly locking the plates relative to each other; and
an armrest secured to the movable hinge plates, whereby, when the plates are locked by the latch means, angular displacement of the armrest relative to the support deforms the blocks.

12. The armrest assembly defined in claim 11 wherein the blocks each have a central hole through which the shaft extends.
